(19) United States
(12) Patent Application Publication
(10) Pub. No.: US 2026/0200053 A1
(43) Pub. Date: Jul. 16, 2026

(54) Bearing Disassembly Device

(71) Applicant: SHIFUKANG INDUSTRIAL.CO., LTD., TAICHUNG CITY (TW)

(72) Inventor: SHANG-YUAN HUANG, Taichung City (TW)

(21) Appl. No.: 19/015,999

(22) Filed: Jan. 10, 2025

(51) Int. Cl. B25B 27/06

(52) U.S. Cl. CPC B25B 27/062

(57) ABSTRACT

A bearing disassembly device is provided, wherein the bearing disassembly device includes: an urging assembly configured to engage with a bearing base housing an outer sleeve; a displacement assembly connected to the urging assembly and capable of being driven by the urging assembly to displace away from the bearing base; and a clamping assembly including a plurality of clamping members each connected to the displacement assembly and including a clamping surface, each of the plurality of clamping members being adjustable to move in a radial direction of the outer sleeve so that the clamping surfaces of the plurality of clamp members clamp the outer sleeve. Thereby, it is the plurality of clamp members can be simply and quickly clamped on the outer sleeve, and the outer sleeve can be removed when the displacement assembly is displaced away from the bearing base.

### BACKGROUND OF THE INVENTION

### Field of the Invention

The present invention relates to a disassembly device, particularly to a bearing disassembly device.

### Description of the Prior Art

Conventionally, the disassembly of bearings is often carried out by impacting or directly pulling the bearing out. However, for a lighter machine equipped with bearings, one hand must hold and support the machine, while the other hand either pulls or impacts with a hammer. This disassembly method causes operational inconvenience and may damage the bearing base and the bearing itself.

Another type of conventional bearing disassembly tool uses an outwardly expandable device to engage the bearing and then further pull it out. However, this type of tool requires additional pulling components and supports specific to the bearing, resulting in numerous components, complex structures, and inconvenient usage.

The present invention is, therefore, arisen to obviate or at least mitigate the above-mentioned disadvantages.

### SUMMARY OF THE INVENTION

The main object of the present invention is to provide a bearing disassembly device with fewer components, a simple structure, and the capability to quickly and easily clamp onto an outer sleeve, enabling easy removal of the outer sleeve.

To achieve the above and other objects, a bearing disassembly device is provided, wherein the bearing disassembly device includes: an urging assembly configured to engage with a bearing base housing an outer sleeve; a displacement assembly connected to the urging assembly and capable of being driven by the urging assembly to displace away from the bearing base; and a clamping assembly including a plurality of clamping members each connected to the displacement assembly and including a clamping surface, each of the plurality of clamping members being adjustable to move in a radial direction of the outer sleeve so that the clamping surfaces of the plurality of clamp members clamp the outer sleeve. Thereby, it is the plurality of clamp members can be simply and quickly clamped on the outer sleeve, and the outer sleeve can be removed when the displacement assembly is displaced away from the bearing base

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is a cross-sectional view of an exemplary embodiment of the present invention;

FIGS. 4 and 5 are bottom views illustrating the operation of an exemplary embodiment of the present invention; and

FIGS. 6 and 7 are cross-sectional views illustrating the operation of an exemplary embodiment of the present invention.

### DETAILED DESCRIPTION OF THE PREFERRED EMBODIMENTS

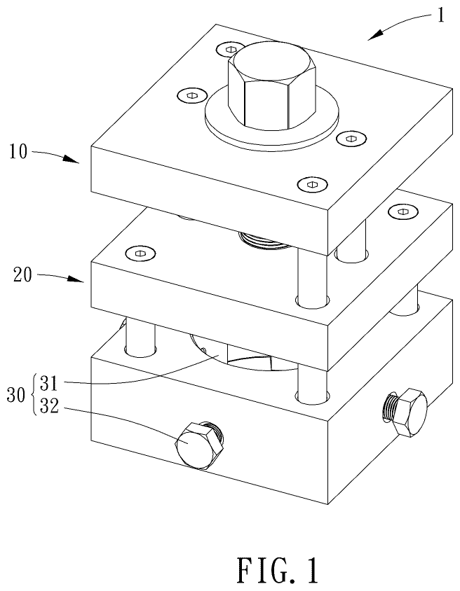

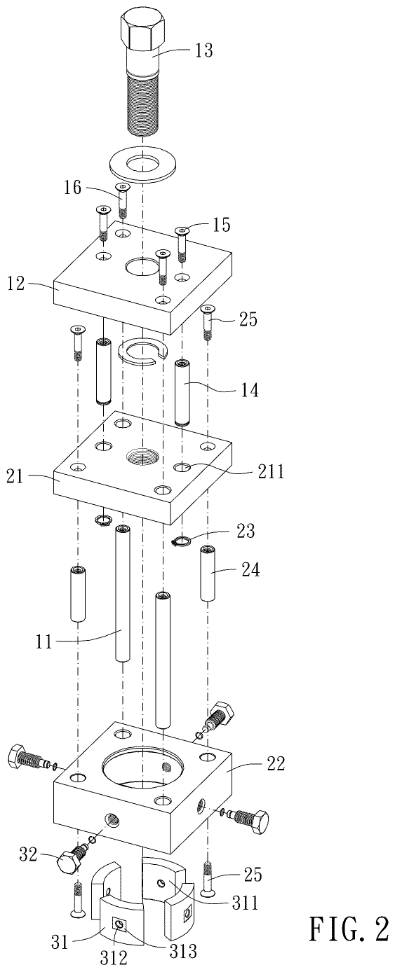

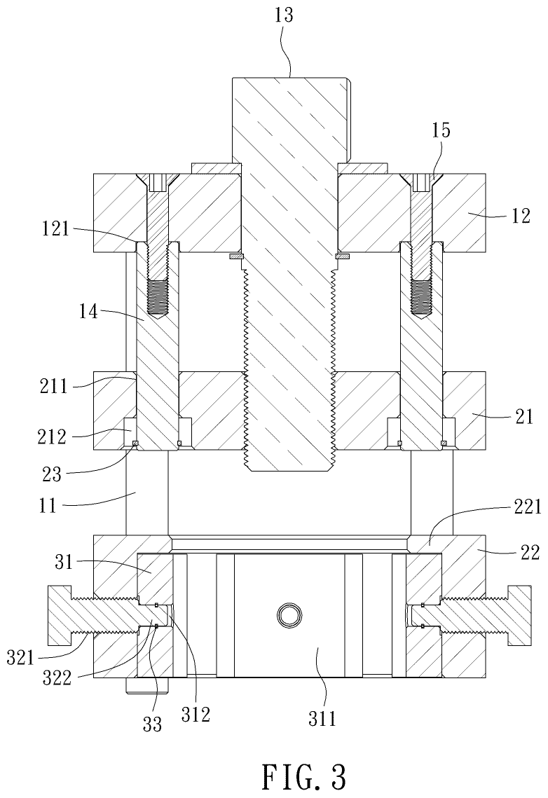

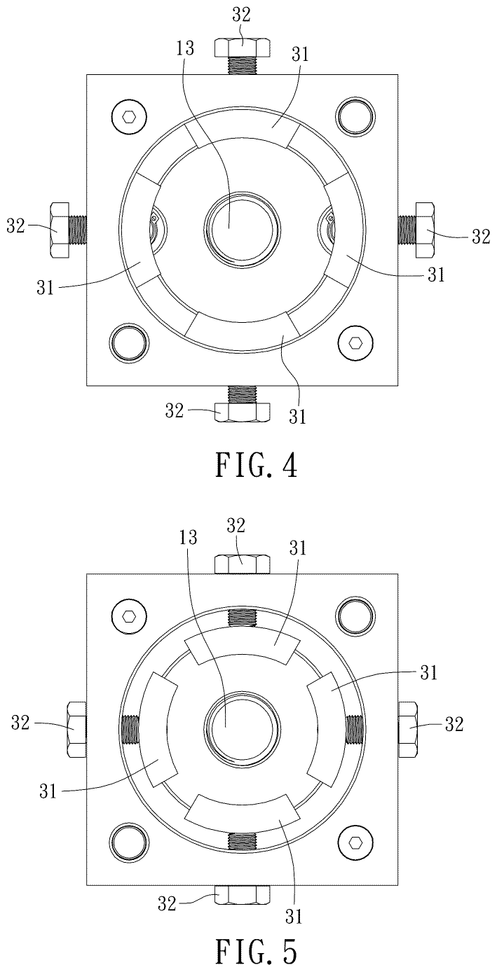

Please refer to FIGS. 1 to 7 for an exemplary embodiment of the present invention. A bearing disassembly device 1 of the present invention includes an urging assembly 10, a displacement assembly 20, and a clamping assembly 30.

The urging assembly 10 is configured to engage with a bearing base 100 which houses an outer sleeve 110. The displacement assembly 20 is connected to the urging assembly 10 and is capable of being driven by the urging assembly 10 to displace away from the bearing base 100. The clamping assembly 30 includes a plurality of clamping members 31 each connected to the displacement assembly 20 and including a clamping surface 311. Each of the plurality of clamping members 31 is adjustable to move in a radial direction of the outer sleeve 110 so that the clamping surfaces 311 clamp the outer sleeve 110. Accordingly, the bearing disassembly device 1 has fewer components and a simple structure. The plurality of clamping members 31 can quickly and easily clamp onto the outer sleeve 110, allowing the outer sleeve 110 to be removed when the displacement assembly 20 is displaced away from the bearing base 100.

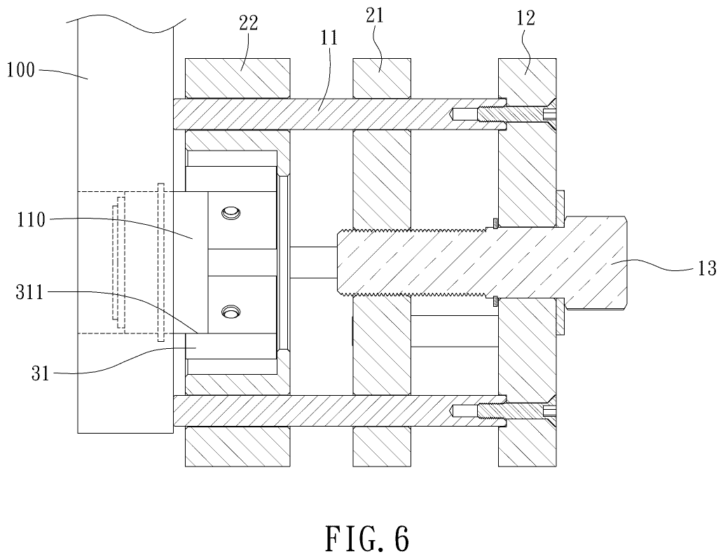

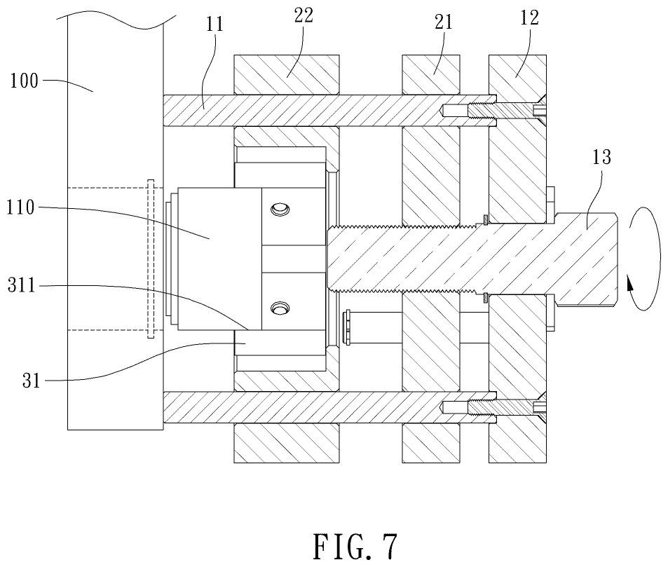

The urging assembly 10 includes at least one column 11. The displacement assembly 20 is slidably disposed on the at least one column 11, and the at least one column 11 is configured to abut the bearing base 100. The at least one column 11 can effectively and stably guide the displacement assembly 20. Specifically, the urging assembly 10 further includes a base 12 and a threaded rod 13 rotatably disposed through the base 12. The at least one column 11 is connected to the base 12, and the threaded rod 13 is screwed to the displacement assembly 20. By rotating the threaded rod 13, the displacement assembly 20 is driven to move with the plurality of clamping members 31 to pull the outer sleeve 110 (FIGS. 6 and 7).

Specifically, the displacement assembly 20 includes a pulling member 21 and a main body 22. The pulling member 21 and the main body 22 are connected to and movable with each other. The at least one column 11 is disposed through at least one of the pulling member 21 and the main body 22. The threaded rod 13 is screwed to the pulling member 21. Preferably, the at least one column 11 is disposed through the pulling member 21 and the main body 22, providing good structural stability and strength. The urging assembly 10 further includes at least one guide rod 14. The base 12 includes at least one recession 121. The at least one guide rod 14 is inserted in the at least one recession 121 and fixed to the base 12, thereby enhancing the stability and strength of the assembly. The pulling member 21 includes at least one through hole 211, and each of the at least one guide rod 14 is inserted in one of the at least one through hole 211 and includes a retainer 23 disposed at an end thereof, allowing the pulling member 21 to move relative to the guide rods 14. The retainer 23 prevents the pulling member 21 from detaching from the guide rod 14.

In this embodiment, the at least one column includes a plurality of columns 11, and the at least one guide rod includes a plurality of guide rods 14. The columns 11 and the guide rods 14 are alternately arranged around the threaded rod 13, ensuring smooth and stable movement of the urging assembly 10 while distributing force evenly. Each guide rod 14 is detachably fixed to the base 12 by a screw 15, facilitating assembly, replacement and maintenance. Each column 11 is detachably connected to the base 12 by a screw 16, facilitating assembly, replacement and maintenance. The displacement assembly 20 further includes a plurality of connection rods 24. Two ends of each of the plurality of connection rods 24 are detachably connected to the pulling member 21 and the main body 22 by screws 25, respectively. This design facilitates assembly, replacement and maintenance. The columns 11 and connection rods 24 are alternately arranged around the threaded rod 13, ensuring smooth and stable movement of the displacement assembly 20 while evenly distributing force. Each through hole 211 includes an enlarged section 212, and the retainer 23 is movable to be positioned within the enlarged section 212, increasing the displacement range of the displacement assembly 20.

Specifically, the clamping assembly 30 further includes a plurality of bolts 32. The plurality of bolts 32 are threadedly and rotatably disposed through the displacement assembly 20, and each of the plurality of bolts 32 is rotatably connected to the plurality of clamping members 31. By rotating the plurality of bolts 32, the plurality of clamping members 31 are moved to clamp the outer sleeve 110. The clamping surfaces 311 of the plurality of clamping members 31 may have the same or different curvature radii, making them suitable for clamping outer sleeves with different diametric dimensions. Preferably, two of the clamping surfaces 311 of the plurality of clamping members 31 which are arranged diametrically opposite to each other have the same curvature radius, thereby providing a good clamping effect.

Specifically, the main body 22 includes a radial flange 221. The radial flange 221 axially blocks the plurality of clamping members 31, effectively supporting and retaining the plurality of clamping members 31 while reducing the force exerted on each of the bolts 32. Each of the plurality of clamping members 31 further includes an insertion hole 312. Each of the bolts 32 is inserted in one of the insertion holes 312 and fastened to a hole wall of the insertion hole 312 by a retainer 33, allowing each of the bolts 32 to freely rotate relative to an associated one of the plurality of clamping members 31. Each of the plurality of clamping members 31 further includes a recess 313 formed around one of the insertion holes 312. Each of the bolts 32 includes a threaded section 321 and a non-threaded section 322 which are connected to each other. The threaded section 321 has a diametric dimension larger than a diametric dimension of the non-threaded section 322. The threaded section 321 is screwed to the displacement assembly 20. The threaded section 321 extends in the recess 313, preventing the threaded section 321 from abutting against the clamping member 31, which allows the clamping member 31 to well fit to the inner surface of the main body 22. The retainer 33 is mounted to the non-threaded section 322 and the non-threaded section 322 is inserted in one of the insertion holes 312, which protects the retainer 33 and prevents the retainer 33 from detaching under external forces.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A bearing disassembly device including:
an urging assembly configured to engage with a bearing base housing an outer sleeve;
a displacement assembly connected to the urging assembly and capable of being driven by the urging assembly to displace away from the bearing base; and
a clamping assembly including a plurality of clamping members each connected to the displacement assembly and including a clamping surface, each of the plurality of clamping members being adjustable to move in a radial direction of the outer sleeve so that the clamping surfaces of the plurality of clamp members clamp the outer sleeve.

2. The bearing disassembly device of claim 1, wherein the urging assembly includes at least one column, the displacement assembly is slidably disposed on the at least one column, and the at least one column is configured to abut the bearing base.

3. The bearing disassembly device of claim 2, wherein the urging assembly further includes a base and a threaded rod rotatably disposed through the base, the at least one column is connected to the base, and the threaded rod is screwed to the displacement assembly.

4. The bearing disassembly device of claim 3, wherein the displacement assembly includes a pulling member and a main body, the pulling member and the main body are connected to each other, the at least one column is disposed through at least one of the pulling member and the main body, and the threaded rod is screwed to the pulling member.

5. The bearing disassembly device of claim 4, wherein the urging assembly further includes at least one guide rod, the base includes at least one recession, the at least one guide rod is inserted in the at least one recession and fixed to the base.

6. The bearing disassembly device of claim 5, wherein the pulling member includes at least one through hole, each of the at least one guide rod is inserted in one of the at least one through hole and includes a retainer disposed at an end, and the pulling member is movable relative to the at least one guide rod.

7. The bearing disassembly device of claim 6, wherein the at least one column includes a plurality of columns, the at least one guide rod includes a plurality of guide rods, the plurality of columns and the plurality of guide rods are alternately arranged around the threaded rod; each of the plurality of guide rods is detachably fixed to the base by a screw; each of the plurality of columns is detachably connected to the base by a screw; the displacement assembly further includes a plurality of connection rods, two ends of each of the plurality of connection rods are each detachably connected to the pulling member and the main body by a screw, respectively; the plurality of columns and the plurality of connection rods are alternately arranged around the threaded rod; each of the at least one through hole includes an enlarged section, and the retainer is movable to be located in the enlarged section; the main body includes a radial flange, and the radial flange axially blocks the plurality of clamping members.

8. The bearing disassembly device of claim 1, wherein the clamping assembly further includes a plurality of bolts, the plurality of bolts are threadedly and rotatably connected to the displacement assembly, and the plurality of bolts are rotatably connected to the plurality of clamping members, respectively.

9. The bearing disassembly device of claim 8, wherein each of the plurality of clamping members further includes an insertion hole, and each of the plurality of bolts is inserted in one of the plurality of insertion holes and fastened to a hole wall of the insertion hole by a retainer.

10. The bearing disassembly device of claim 9, wherein each of the plurality of clamping members further includes a recess in one of the plurality of insertion holes, each of the plurality of bolts includes a threaded section and a non-threaded section, the threaded section has a diametric dimension larger than a diametric dimension of the non-threaded section, the threaded section is screwed to the displacement assembly, the threaded section extends in the recess, the non-threaded section is inserted in one of the plurality of insertion holes, and the retainer is mounted to the non-threaded section.
